(19) United States
(12) Patent Application Publication
(10) Pub. No.: US 2007/0187401 A1
(43) Pub. Date: Aug. 16, 2007

(54) Microwaves blocker apparatus for opening microwaves oven

(76) Inventor: Sergio Quinta, Sao Paulo (BR)

Correspondence Address: STITES & HARBISON PLLC, 1199 NORTH FAIRFAX STREET, SUITE 900, ALEXANDRIA, VA, 22314, US

(21) Appl. No.: 10/576,954

(22) PCT Filed: Oct. 22, 2004
(86) PCT No.: PCT/BR04/00216

§ 371 Date: Apr. 24, 2006

(30) Foreign Application Priority Data
Oct. 22, 2003 (BR) PI306893-5

(51) Int. Cl. H05B 6/76

(52) U.S. Cl. 219/736

(57) ABSTRACT

Microwaves blocker apparatus (1) installed at the entrance, front part and also at the exit, hinder part, of an opening microwaves oven (5), turning round the oven's entrance and exit allowing free passage (6) of materials to be processed, which dimension and shape follow the format of the oven where it is installed, being such apparatus still surrounded by a metallic material (3).

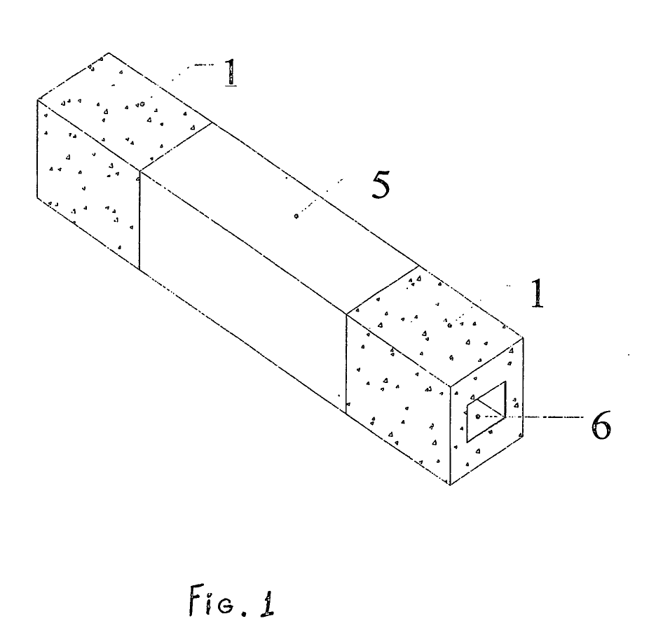

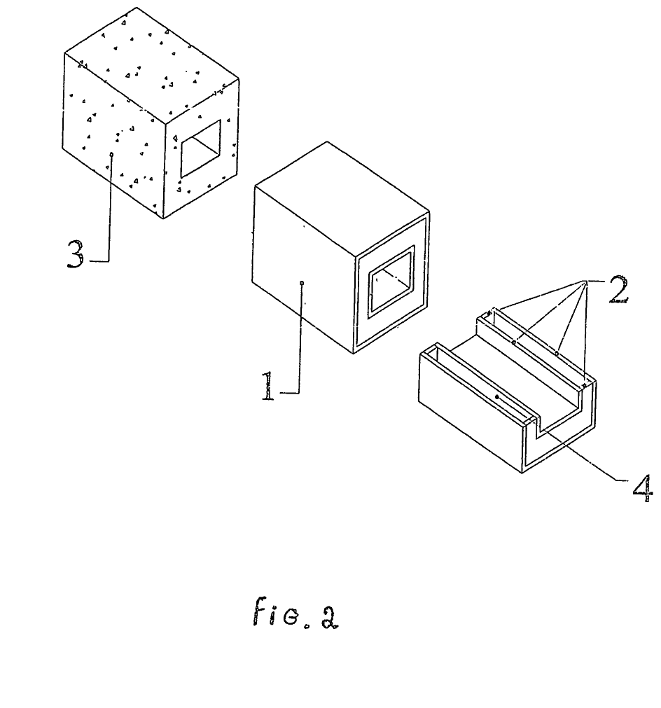

The Microwaves Blocker Apparatus, treated in the present patent's claim, refer to a mechanic apparatus which prevents the leakage of microwaves applied to opening microwaves oven, avoiding its propagation outside the oven and allowing the continuous, uniform and safe materials operation.

The materials process in ovens includes the possibility of tiring, dehydrate, toasting, heating, baking, cooking, sterilizing, carbonizing or pasteurizing various nature materials. The process of tiring materials, mostly those used in industrial scale like wood, gypsum, grains, herbs and rations, nowadays, is realized by ovens or tiring chambers that use as thermal spring steams, heat deriving from electric resistors or from inflammable materials combustion. Generally, these operations are realized in closed environments, being slow, expensive and many times producing toxic residues, when compared to microwaves operations.

Recently, a little more than six years ago, there are some trials to introduce the microwaves in industrial processes of materials operations. The claims of brazilian patents, for instance the invention's claim PI 9606222 of Dec. 30, 1996 and the pattern utility's claim MU 902000 of Sept. 16, 1999, show that there are trials of applications in this area.

The use of microwaves to the materials' tiring operation, very utilized in the industrial sector, is fasten when compared to operations already known and utilized for tiring. Deserves notability here the wood tiring, almost always using the operations that need thermal springs which first heat the oven where the materials are set, and later heat the materials gradually until the humidity is completely eliminated. This way, the heating happens from the exterior environment to the interior of the materials to be tire and, depending on its volumes, many days are necessary to happen the complete tiring, needing, generally, the construction of big dimensions ovens, feeding by heat systems which consume great quantity of natural resources in the heat production.

The tiring operation using microwaves is much more efficient and economic. It is realized from the material heat by the vibration of its molecules, reducing the energetic costs, since the energy is consumed just to heat the material, without lost of energy to the environment. This reduces the quantity of energy necessary to the materials operation, when compared to the systems already known and used for tiring operations.

Specifically, you can use the microwaves oven for tiring and reducing the wood hygroscopicity, or, if it is already tire, just do the thermic treatment to reduce the capacity of absorb water from the environment.

The thermic treatment affects the wood's structure by the modification of its three major components: cellulose, lignin and hemicellulose. The cellulose and lignin's modification cause changes in mechanic properties, while the hemicellulose's degradation causes changes at the hygroscopic capacity of the wood, also allowing the quickly evaporation of any water which penetrate at the surface. This contribute to the dimensional stability and fungus resistance's increase.

The use of microwaves in industrial operations, nowadays, happens just in closed ovens, since the opening oven would allow the propagation of microwaves to the environment outside the oven, what could cause damages to human health and objects. Although the security, the closed oven has a factor which limits its use in materials' continuous operation.

The present invention (1) allows the implementation of technical solution to the problems pointed above, when installed at the two edges of an opening microwaves oven (5), turning round its entrance, front part and its exit, hinder part. This way, the materials can be crossed through the interior (6) of the oven, using mats, small wheels or other supporting mechanisms.

The application of this invention (1) makes the use of opening microwaves oven safe and allows the materials operation be made in a continuous way.

The blocker apparatus (1) is applied in opening microwaves oven which can be constructed in format of a tunnel (5), with materials resistant to the microwaves effects and have dimensions and forms variables, depending on the volume and nature of the materials to be processed. The openings of the opening microwaves oven's edges (6), entrance (front part) and exit (hinder part), allow the materials to be processed to be introduced by one edge and taken out by the other, guaranteeing this way the efficiency of a materials' continuous operation, that can be fasten with the help of a mat or any other mechanism. When across the oven, the materials stay exposed to the microwaves in its interior for the time necessary to the process be completed, considering the diverse natural characteristics of any material.

The present invention, named “Microwaves Blocker Apparatus in Opening Microwaves oven”, executes exactly the function of block the eventual microwaves that try to go out the interior of the opening microwaves ovens, allowing a continuous and safe process of materials.

The microwaves blocker apparatus is constituted by a chamber (2) which interior (4) must be fulfilled with substances capable to absorb the microwaves. These substances can be water consistence, sugars, blubbers or any others that have the capacity of absorb microwaves, being these used with volume, quantity and thickness capable to attend the standard prescribed in rules of security to levels of exposition to the microwaves. The chamber (2) has an opening with a cover appropriate to introduction and reposition of substances.

The chamber (2) circles the form of the oven's entrance and exit, leaving free the passage of the materials to be process (6). The walls of the chamber (2) of the microwaves blocker apparatus (1) must be constituted by dielectric material, because this kind of material doesn't avoid the microwaves passage to the substance that fill its interior, fundamental principle to the good functioning of the blocker apparatus. To attend security questions, the outside wall of the chamber must be involved by a frame constituted by metallic material (3).

The drawings annexed show the application of the present invention. At Picture 1, the blocker apparatus (1) appear installed at the edges of an opening microwaves oven (5) constructed in form of a tunnel and having in the center an opening (6) to allow introduce materials to be process in its interior and taken off by the other oven's edge. At Picture II, it's illustrated the external appearance of the blocker apparatus (1) and its internal appearance (4) wherein deposits of substances that absorb microwaves, beyond the constructive form of the chamber (2) constituted by walls of of dielectric materials capable to conditioning the absorb substances and allow the insertion of microwaves in the chamber. At Picture II, it's also illustrated a frame constituted by metallic material (3), appropriate to involve the blocker apparatus completely.

The functioning principle of the present invention is related to the security of the industrial microwaves ovens. Thus, being installed at the opening microwaves oven's edges, the present invention (1), concerning its construction form, follows the oven's geometry, fitting as if it was an extension of the oven, creating security spaces between the materials' entrance and exit for processing inside the oven (5).

The blocker apparatus' constructive dimensions vary according to the security space necessary between the materials' entrance and exit in the process oven, not allowing the easy attaching of the operators in case of hands, arms and forearms put inside the oven where the microwaves are applied.

The invention works as a microwaves absorb, attracting to its interior the eventual microwaves which, for any reason, try to escape from the oven's interior during its working and try to go outside.

The present invention was tested in laboratories that tried to evaluate its working security; The tests were made watching the samples established at following rules: a) NBR NM—IEC 335-1, November, 1998; b) Security of Electrical Appliances and similar—Part 1—General requisites and the IEC 335-2-25, July 1996; c) Safety of Household and similar electrical Appliances—Part 2; d) Particular Requirements of microwaves Ovens.

The rules used as basis for essays realization establish as safe until 5 (five) milliwatts per centimeter square as maximum level of users exposition to the microwaves. The microwaves' blocker apparatus, taken to lab tests to verify its security according to the sample showed above, seemed completely safe, presenting, per centimeter square, index 10 times less than the 5 (five) milliwatts accepted.

1. Microwaves blocker apparatus for opening microwaves ovens installed at the entrance, front part and also at the exit, hinder part, of an opening microwaves oven, turning round the oven's entrance and exit allowing the free passage of the materials to be processed, characterized by a chamber constructed of dielectric material and surrounded by metallic material, which dimensions and forms follow the oven's shape in which it is installed.

2. Microwaves blocker apparatus for opening microwaves oven according to claim 1, characterized by a chamber which size, from the oven's entrance and exit, must avoid that a person's hands or arms touch the oven's interior.

3. Microwaves blocker apparatus for opening microwave oven according to claim 1, characterized by a chamber which interior must be fulfilled with substances of water consistence, sugars, blubbers or any others that have the microwaves absorb capacity, all deposited in the chamber with volume, quantity or thickness capable to attend the standards of security prescribed at technical rules for levels of exposition to the microwaves.

4. Microwaves blocker apparatus for opening microwaves oven according to claim 1, characterized by a chamber with an opening with cover, appropriate to introduction and reposition of substances.

5. Microwaves blocker apparatus for opening microwaves oven according to claim 1, used opened or closed for wood's thermic treatment with the objective to reduce the wood's and improve the dimensional stability.
